(19) United States
(12) Patent Application Publication
(10) Pub. No.: US 2008/0313744 A1
(43) Pub. Date: Dec. 18, 2008

(54) Computer Readable Medium Embodying Control Program, Image Forming Apparatus, Control System, and Control Method

(76) Inventors: Takeshi Nakajima, Tokyo (JP); Hirohiko Yamazaki, Tokyo (JP); Koichi Kitamoto, Tokyo (JP); Tsuyoshi Yoneyama, Tokyo (JP)

Correspondence Address: Cameron Kerrigan;Squire, Sanders & Dempsey L.L.P., Suite 300, One Maritime Plaza, San Francisco, CA, 94111, US

(21) Appl. No.: 12/046,355

(22) Filed: Mar. 11, 2008

(30) Foreign Application Priority Data
Jun. 12, 2007 (JP) 2007-155687

(51) Int. Cl. G06F 21/00

(52) U.S. Cl. 726/28

(57) ABSTRACT

Disclosed a computer readable medium embodying a control program enabling a computer to function as: a save control section to save document data of a first document including secret information at a predetermined saving position; a code generating section to generate a code in which address information of the saving position and opening range information defining an opening range of users to whom the secret information is opened are recorded; and an output control section to enable printing or displaying a second document in which a specified position of the first document is obscured and the code is added.

### BACKGROUND

1. Field of the Invention

The present invention relates to a computer readable medium embodying a control program, an image forming apparatus, a control system, and a control method, and more particularly to a computer readable medium embodying a control program for preventing the leakage of secret information in a document and for utilizing the secret information properly, an image forming apparatus, a control system, and a control method.

2. Description of Related Art

A copier and a multi function peripheral (MFP) (which are hereinafter generically referred to image forming apparatus), each having a copying function, a facsimile function, a printer function, a scanner function, and the like, have become common, and are widely used in companies. The documents printed with the image forming apparatus include the ones to which all users can access and the ones containing secret information to which only specific users can access. If the latter document is printed, then it is necessary to control the printing lest the secret information should leak out.

Regarding the print control, for example, Japanese Patent Application Laid-Open Publication No. 2004-240748 discloses an output data processing apparatus that changes the display color of a data part that needs security guard to the same color as that of the background thereof and displays the other data parts that do not need the security guard in conformity with an output format when such a data part is included in an accessed document file.

However, the output data processing apparatus is configured to compare the security level of each data part constituting a document file with a client level to judge whether secret information the access of which is limited to the client is included in the document or not when the client accesses the document file. If the secret information is included, then the output data processing apparatus performs the security guard to the client. Consequently, the client himself or herself has no recognition of at which level the information is opened to the client, and the client sometimes outputs printed matter in which secret information including the limitation of the opening thereof to another client is not obscured. Hence, there is a problem of a leak of the secret information when the address for distribution of the printed matter is mistaken. Moreover, there is also a problem of a similar leak of the secret information in the case of an instruction of printing by computer equipment even if the access of the document file is performed with the computer equipment.

Moreover, because no information pertaining to the access authority of the secret information is displayed, it is impossible to know from which level the access of the secret information can be performed even if the printed matter is looked at, and there is also a problem of the impossibility of informing a user who has the access authority of the secret information surely.

### SUMMARY

In order to solve at least one of the problems mentioned above, a computer readable medium embodying a control program reflecting an aspect of the present invention, an image forming apparatus, a control system, and a control method have the following configurations.

To achieve the objects mentioned above, according to the first aspect of the invention, a computer readable medium embodying a control program enables a computer to function as: a save control section to save document data of a first document including secret information at a predetermined saving position; a code generating section to generate a code in which address information of the saving position and opening range information defining an opening range of users to whom the secret information is opened are recorded; and an output control section to enable printing or displaying a second document in which a specified position of the first document is obscured and the code is added.

According to the second aspect of the invention, a computer readable medium embodying a control program enables a computer to function as: a save control section to save partial data at a specified position in a first document including secret information at a predetermined saving position; a code generating section to generate a code in which address information of the saving position and opening range information defining an opening range of users to whom the secret information is opened are recorded; and an output control section to enable printing or displaying of a second document in which the specified position in the first document is obscured and the code is added.

According to the third aspect of the invention, an image forming apparatus, includes: a display section to display a first document including secret information; an operation section to enable specifying a position to be obscured in the first document and setting opening range information defining an opening range of users to whom the secret information is opened; a save control section to save document data of the first document at a predetermined saving position; a code generating section to generate a code in which address information of the saving position and the opening range information are recorded; and an output control section to enable printing or displaying a second document in which the specified position of the first document is obscured and the code is added.

According to the fourth aspect of the invention, an image forming apparatus, includes: a display section to display a first document including secret information; an operation section to enable specifying a position to be obscured in the first document and setting opening range information defining an opening range of users to whom the secret information is opened; a save control section to save partial data at an specified position in the first document at a predetermined saving position; a code generating section to generate a code in which address information of the saving position and the opening range information are recorded; and an output control section to enable printing or displaying a second document in which the specified position in the first document is obscured and the code is added.

According to the fifth aspect of the invention, a control system in which an image forming apparatus and computer equipment are connected to each other through a communication network, wherein the computer equipment includes: a display section to display a first document including secret information; an operation section to enable specifying a position to be obscured in the first document and to set opening range information defining an opening range of users to whom the secret information is opened; a save control section to save document data of the first document at a predetermined saving position; a code generating section to generate a code in which address information of the saving position and the opening range information are recorded; and an output control section to allow the display section to display a second document in which the specified position in the first document is obscured and the code is added, or to allow the image forming apparatus to print the second document.

According to the sixth aspect of the invention, a control system includes an image forming apparatus and computer equipment, both connected to each other through a communication network, wherein the computer equipment includes: a display section to display a first document including secret information; an operation section to enable specifying a position to be obscured in the first document and to set opening range information defining an opening range of users to whom the secret information is opened; a save control section to save partial data at a specified position in the first document at a predetermined saving position; a code generating section to generate a code in which address information of the saving position and the opening range information are recorded; and an output control section to allow the display section to display a second document in which the specified position of the first document is obscured and the code is added, or to allow the image forming apparatus to print the second document.

According to the seventh aspect of the invention, a control method includes the steps of: displaying a first document including secret information; specifying a position to be obscured in the first document to set an opening range information defining an opening range of users to whom the secret information is opened; saving document data in the first document at a predetermined saving position; generating a code in which address information of the saving position and the opening range information are recorded; and displaying or printing a second document in which the specified position of the first document is obscured and the code is added.

According to the eighth aspect of the invention, a control method includes the steps of: displaying a first document including secret information; specifying a position to be obscured in the first document to set opening range information defining an opening range of users to whom the secret information is opened; saving partial data at a specified position in the first document at a predetermined saving position; generating a code in which address information of the saving position and the opening range information are recorded; and displaying or printing a second document in which the specified position of the first document is obscured and the code is added.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a view schematically showing a configuration of a control system according to a first embodiment of the present invention;

FIG. 2 is a view schematically showing another configuration of the control system according to the first embodiment of the present invention;

FIG. 3 is a block diagram showing the configuration of an image forming apparatus according to the first embodiment of the present invention;

FIG. 4 is a block diagram showing the configuration of a control section of the image forming apparatus according to the first embodiment of the present invention;

FIG. 5 is a flowchart showing a procedure of producing a document, saving data, and outputting data by the use of the control system according to the first embodiment of the present invention;

FIG. 6 is a flowchart showing a procedure of an access of secret information by the use of the control system according to the first embodiment of the present invention;

FIG. 7 is a view showing a configuration example of an original document according to the first embodiment of the present invention;

FIGS. 8A and 8B are views showing configuration examples of a screen (obscuring position specifying screen) displayed on the image forming apparatus according to the first embodiment of the present invention;

FIGS. 9A and 9B are views showing configuration examples of a screen (opening range setting screen) displayed on the image forming apparatus according to the first embodiment of the present invention;

FIG. 10 is a view showing a configuration example of a processed document according to the first embodiment of the present invention;

FIG. 11 is a view showing another configuration example of a processed document according to the first embodiment of the present invention;

FIGS. 12A and 12B are views showing further configuration examples of a processed document according to the first embodiment of the present invention;

FIGS. 13A and 13B are views showing display examples of partial data according to the first embodiment of the present invention;

FIG. 14 is a view schematically showing the configuration of a control system according to a second embodiment of the present invention;

FIG. 15 is a block diagram showing the configuration of computer equipment according to the second embodiment of the present invention;

FIG. 16 is a block diagram showing the configuration of the computer equipment according to the second embodiment of the present invention; and

FIG. 17 is a flowchart showing a procedure of producing a document, saving data, and outputting data by the use of the control system according to the second embodiment of the present invention.

### DETAILED DESCRIPTION OF THE PREFERRED EMBODIMENT

In a preferred embodiment of the present invention, an image forming apparatus is provided, as hardware or software, with a save control section saving original document data including secret information, or partial data at a specified position of an original document, at a predetermined saving position; a code generating section generating a code in which the address information of the saving position of the original document data or the partial data, and opening range information are recorded; an output control section printing or displaying a processed document in which a specified position is painted out and a code is added; and an authentication section authenticating whether a user utilizing the processed document agrees with the opening range or not, and allowing the user to access the saving position if the user agrees with the opening range. By printing or displaying the processed document like this, the leak of the secret information can be previously prevented. Moreover, the user agreeing with the opening range can perform the access of the secret information by reading the code and accessing the saving position. Furthermore, by printing/displaying the processed document with added opening range information at a painting place, the user utilizing the processed document can easily judge whether the user himself or herself agrees with the opening range or not.

### First Embodiment

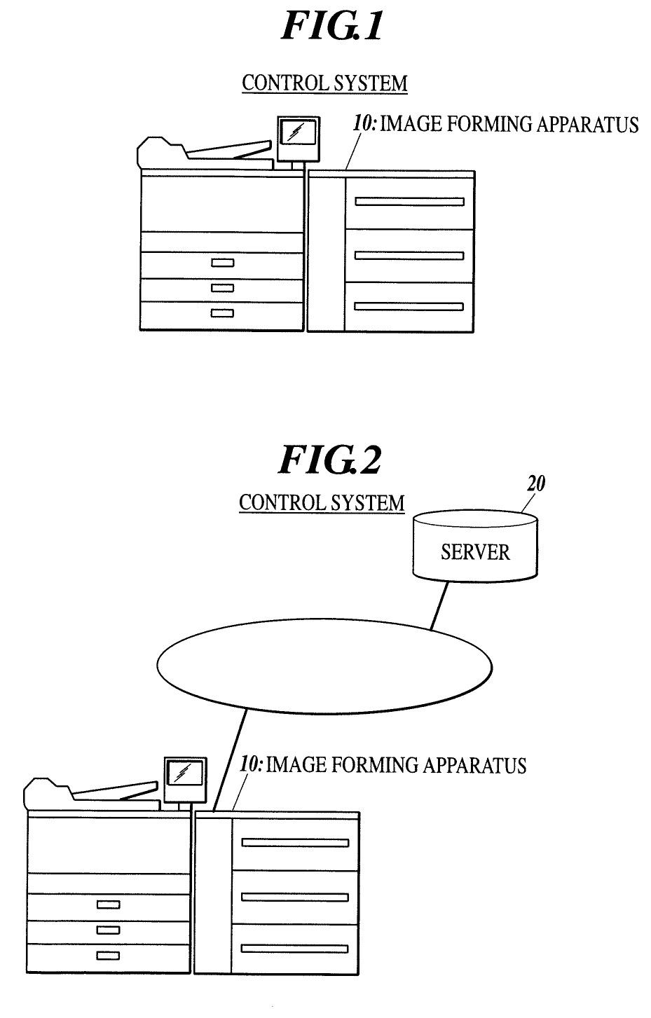

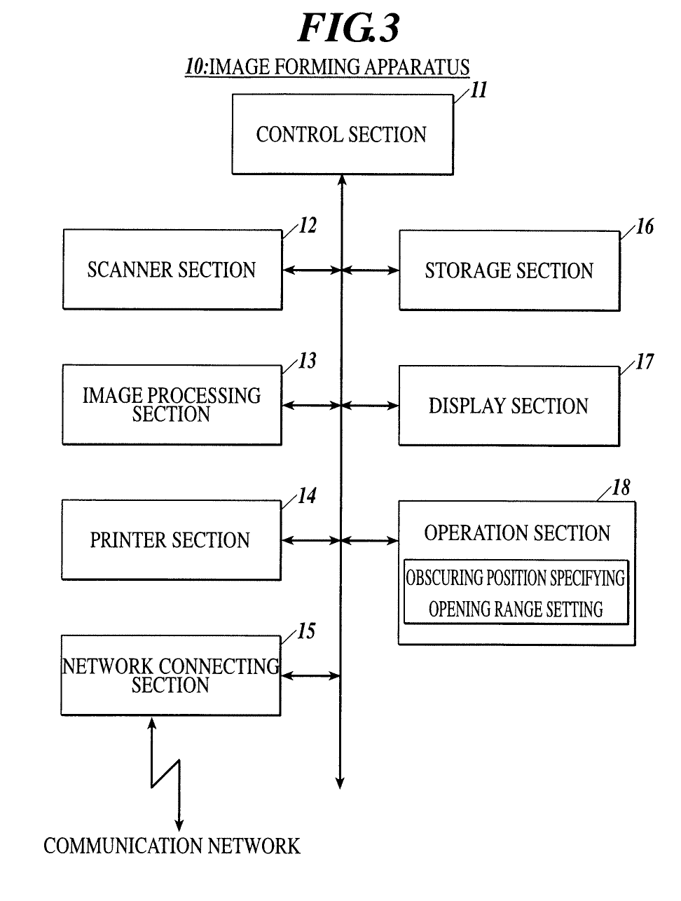

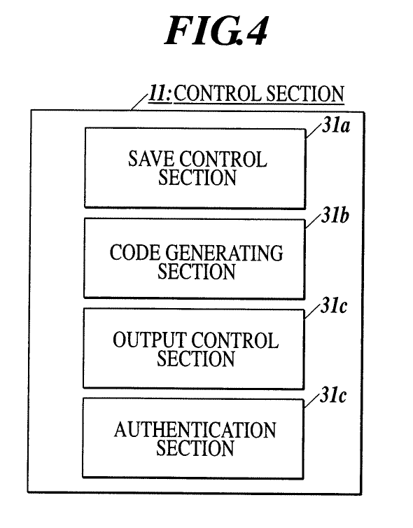

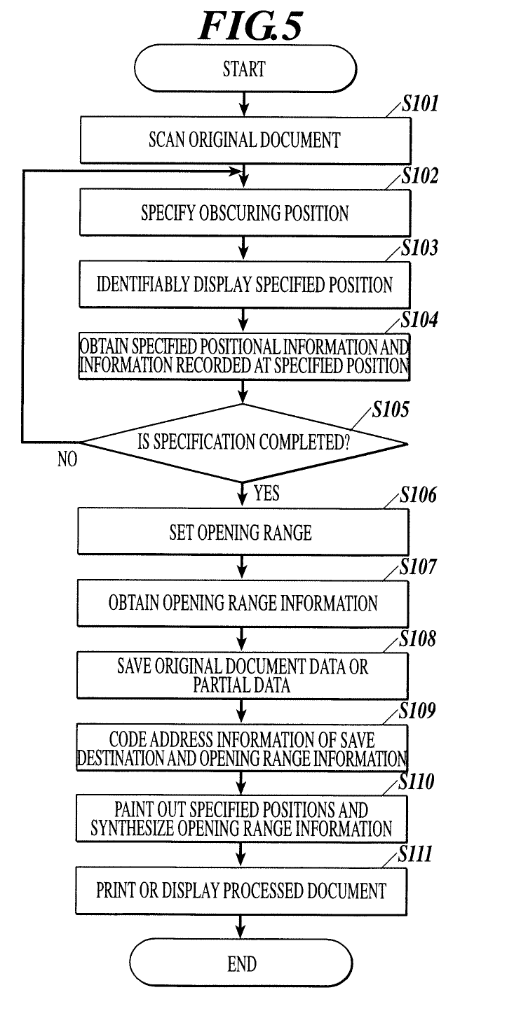

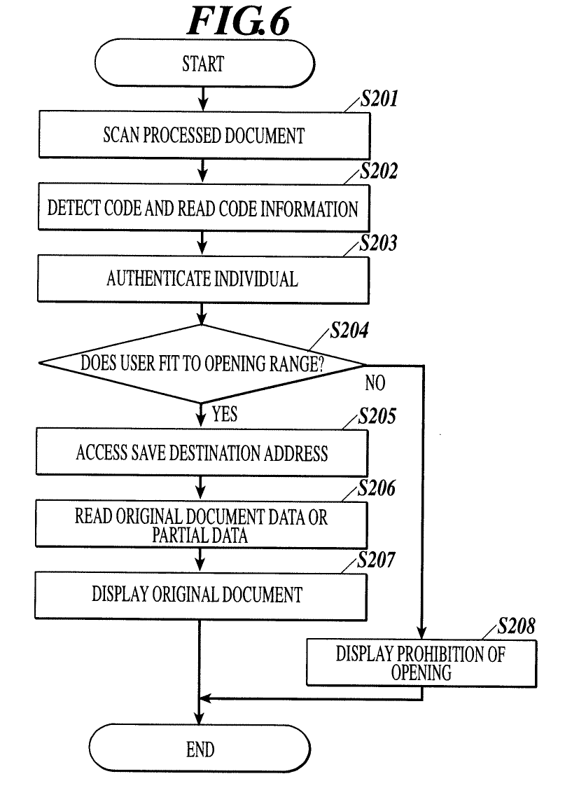

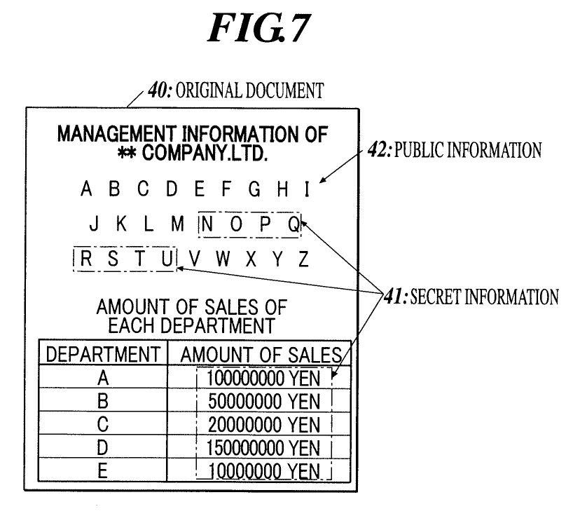

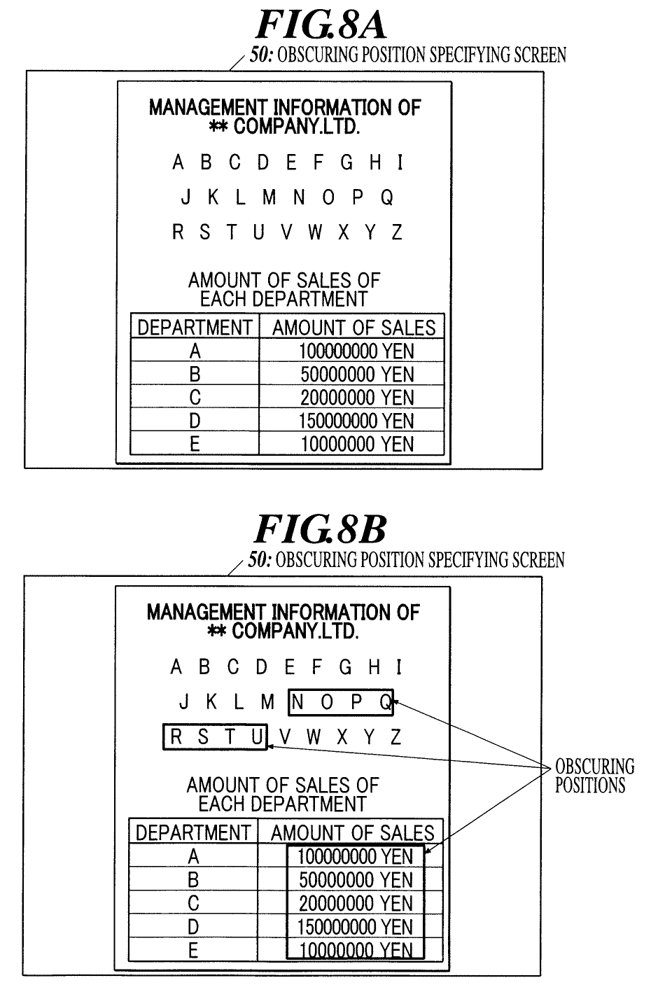

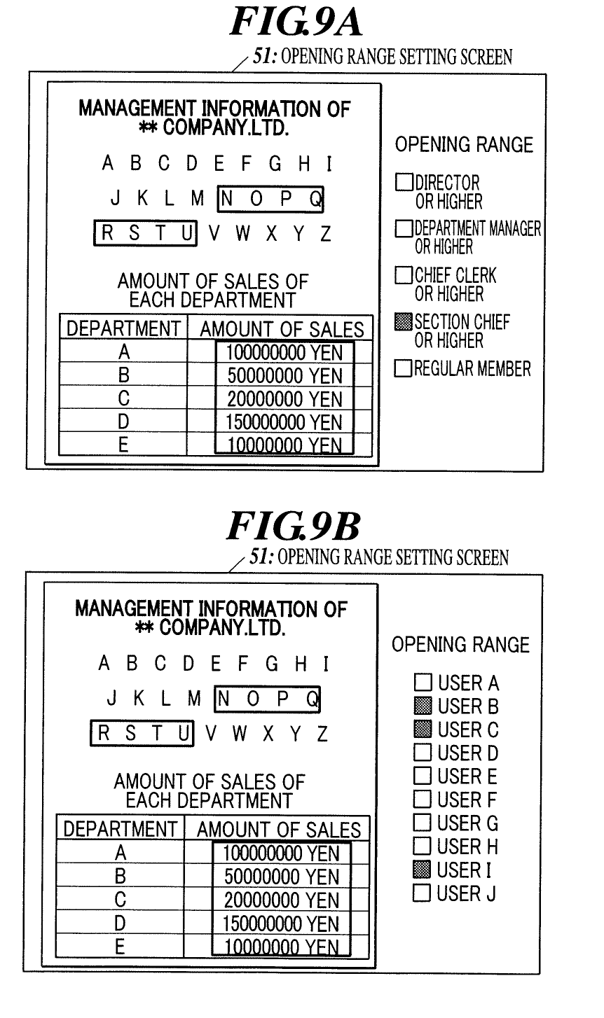

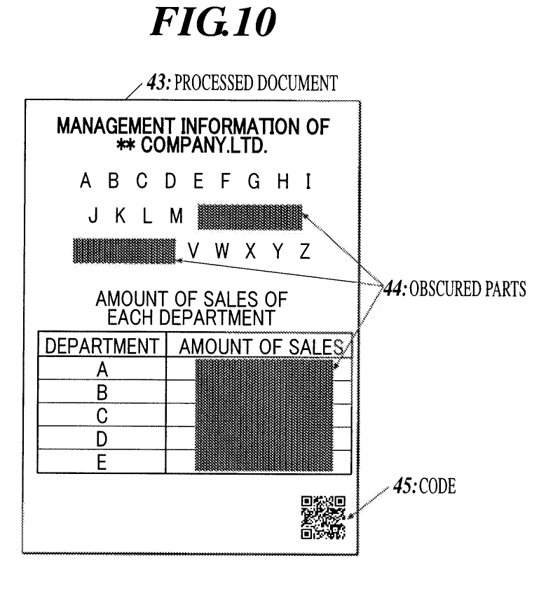

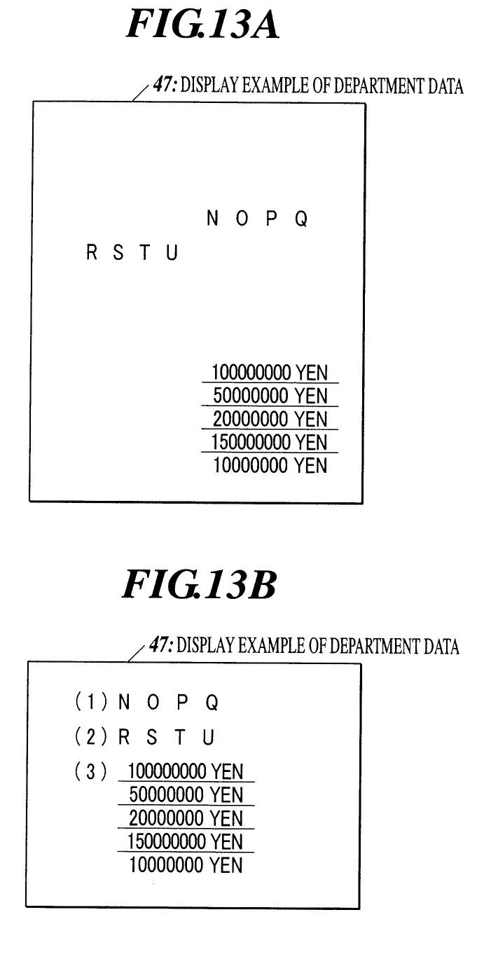

A control program, an image forming apparatus, a control system, and a control method according to a first embodiment of the present invention are described with reference to FIGS. 1-13B in order to give further detail description to the aforesaid embodiment of the present invention. FIGS. 1 and 2 are views schematically showing the configuration of the control system of the present embodiment; FIG. 3 is a block diagram showing the configuration of the image forming apparatus of the present embodiment; FIG. 4 is a block diagram showing the configuration of a control section of the image forming apparatus. Moreover, FIG. 5 is a flowchart showing a procedure of producing a document, saving data, and outputting data by the use of the control system of the present embodiment, and FIG. 6 is a flowchart showing an access procedure of secret information by the use of the control system of the present embodiment. Moreover, FIG. 7 is a view showing a configuration example of an original document of the present embodiment, and FIGS. 8A, 8B, 9A, and 9B are views showing configuration examples of screens displayed on a display section of the image forming apparatus of the present embodiment. Moreover, FIGS. 10-12B are views showing configuration examples of processed documents of the present embodiment, and FIGS. 13A and 13B are views showing display examples of partial data of the present embodiment.

As shown in FIG. 1, the control system of the present embodiment is composed of an image forming apparatus 10 performing the printing and the display of a second document (hereinafter referred to as a processed document), the access control of secret information, and the like. The processed document is the one in which specified positions of a first document (hereinafter referred to as an original document) are obscured. The original document includes the information that should be opened to only the users having access authority (hereinafter referred to as secret information).

The image forming apparatus 10 is composed of a control section 11, a scanner section 12, an image processing section 13, a printer section 14, a network connecting section 15, a storage section 16, a display section 17, an operation section 18, and the like, as shown in FIG. 3. Each section is connected with one another through a bus.

The control section 11 is composed of a central processing unit (CPU), a read only memory (ROM), a random access memory (RAM), and the like. The CPU reads various programs stored in the ROM by an operation of the operation section 18, and expands the read programs in the RAM. The CPU controls the operation of each section of the image forming apparatus 10 in accordance with the expanded programs.

The scanner section 12 reads the information recorded on an original such as an original document and a processed document, and is composed of a light source scanning an original, a charge coupled device (CCD) converting a light reflected by the original into an electric signal, an A/D converter performing the A/D conversion of an electric signal, and the like.

The image processing section 13 performs various kinds of image processing, such as the expansion/reduction, the rotation, the frequency conversion, the color conversion from RGB data to YMCK data, and the tone correction of the image read by the scanner section 12 (hereinafter referred to as a scan image). The image processing section 13 outputs the processed image to the printer section 14. Moreover, the image processing section 13 is provided with the function of detecting a one-dimensional bar code, a two-dimensional code, or the like (hereinafter totally referred to a code) from the scan image.

The printer section 14 is composed of an image forming section forming an image to be printed on a transfer paper, a transfer section transferring the formed image to the transfer paper, a fixing section fixing the transferred image, a conveyance section conveying the transfer paper, a cleaning section cleaning the image forming section, the transfer section, and the fixing section, and the like. The printer section 14 forms the image on the transfer paper by an electrophotographic printing system on the basis of input data, and outputs the transfer paper.

The network connecting section 15 is composed of a network interface card (NIC), a modem, a LAN adapter, a router, a terminal adapter (TA), and the like, and performs the control of communications with equipment connected through a communication network.

The storage section 16 is composed of a flash memory, a hard disk, or the like, and stores various data, set conditions, and the like. In the present embodiment, the storage section 16 especially stores the document data of an original document (hereinafter referred to as original document data), the data recorded at a position where a user has specified to the original document (hereinafter referred to as partial data), a table for setting a range of users to whom secret information is opened (hereinafter referred to as opening range), IDs and passwords for authenticating a user, a password to each opening range, and the like.

The display section 17 is composed of a liquid crystal display (LCD) apparatus, an organic electroluminescence (EL) display apparatus, or the like. The display section 17 displays a screen for specifying an obscuring position of an original document read by the scanner section 12, a screen for setting an opening range, and the like, on the screen of the display section 17 in accordance with a display signal from the control section 11. Moreover, the operation section 18 is composed of operation buttons, a mouse, and the like. The operation section 18 enables the operations such as specifying an obscuring position to an original document and setting an opening range of the information recorded at an obscuring position on the screens displayed by the display section 17. Incidentally, the display section 17 and the operation section 18 may be formed as apparatus separated from each other, or may be formed as a unit in which a pressure sensitive operation section (touch panel) 18 with transparent electrodes arranged in a reticular pattern is disposed on the display section 17. In case of the touch panel, the touch panel detects the X-Y coordinates of a power point depressed by a finger, a touch pen, or the like, as a voltage value, and outputs the detected position signal to the control section 11 as an operation signal.

Moreover, in addition to the control of the operation of each section of the image forming apparatus 10, the control section 11, as shown in FIG. 4, also functions as a save control section 11a saving original document data or partial data at a predetermined saving position, a code generating section 11b generating codes such as one-dimensional bar codes or two-dimensional codes by coding the information for specifying the saving position (such as address information) and the information for indicating an opening range (hereinafter referred to as opening range information) and by recording the coded information, an output control section 11c printing or displaying a processed document produced by obscuring the specified positions of an original document and by adding the codes to the original document, and an authentication section lid authenticating whether a user requires an access of secret information agrees with a set opening range or not to allow the user who is authenticated to agree with the opening range to access the saving position.

Incidentally, the save control section 11a, the code generating section 11b, the output control section 11c, and the authentication section 11d may be configured as hardware or may be configured as a control program making a computer function as the save control section 11a, the code generating section 11b, the output control section 11c, and the authentication section 11d to be operated on the control section 11.

Moreover, in the present embodiment, the case of storing the original document data and the partial data in the storage section 16 of the image forming apparatus 10 is shown, but, for example, as shown in FIG. 2, the control system may be configured in such a way that the image forming apparatus 10 and a server 20 are connected to each other through a communication network, such as a local area network (LAN) or a wide area network (WAN), to save the original document data and the partial data in an apparatus, such as the server 20, situated at a place other than that of the image forming apparatus 10.

In the following, a procedure of from producing a processed document to outputting the produced processed document by means of the image forming apparatus 10 configured as above will be described with reference to the flowchart of FIG. 5.

An original document 40 in which secret information 41 and the information the opening of which to the public is not limited (hereinafter referred to as public information 42) are printed as shown in FIG. 7 is first set in the image forming apparatus 10 at Step S101. When a user operates the operation section 18 to instruct a scan, the scanner section 12 scans the original document 40 with the light source, and the light reflected from the original document 40 is received with the CCD to be converted to an electric signal. The electric signal is subjected to an A/D conversion to produce a scan image recording the information of the original document 40. The control section 11 then allows the display section 17 to display an obscuring position specifying screen 50 as shown in FIG. 8A. Incidentally, the configuration of scanning the original document 40 is shown here, but the configuration of making the display section 17 display the original document data stored in the storage section 16 of the image forming apparatus 10 in advance or the original document data received through the communication network may be adopted.

At Step S102, the user next specifies an obscuring position by operating the operation section 18. The specifying method of the obscuring position is not specially limited, but a range may be specified, or a start point and an end point of a document may be specified. Furthermore, coordinates may be input. Moreover, the obscuring position may be one or plural.

At Step S103, the control section 11 next allows the display section 17 to identifiably display the obscuring position specified with the operation section 18. Also the displaying method is arbitrary, and a specified obscuring position may be displayed in the state of being enclosed by a frame as shown in FIG. 8B, or may be displayed by being colored with a different color. Furthermore, the specified obscuring position may be displayed with an added decoration such as half-tone dot meshing.

At Step S104, the control section 11 next obtains the information indicating an obscuring position (hereinafter referred to as specified positional information) on the basis of the information from the operation section 18. Incidentally, it is possible to set the specified positional information as the coordinates of corner parts (the coordinates of the diagonal corners in the case of a rectangle range) in the case of the specification of the range, or to set the specified positional information as the coordinates of a start point and an end point in the case of the specification of the start point and the end point of a document. Moreover, in the case of saving partial data, the control section 11 obtains the information (which may be a text such as a character, a numeral, and a symbol, or may be an image such as a picture and a graph) recorded at an obscuring position. At that time, if the information recorded at the obscuring position is a text, the control section 11 may obtain the character, the numeral, or the symbol at a specified position as image information, or may obtain the character, the numeral, or the symbol as text information by the use of a publicly known character recognizing technique.

Next, when the specification of the obscuring positions has been completed at Step S105, the control section 11 allows the display section 17 to display an opening range setting screen at Step S106. The opening range setting screen is a screen for defining the range of the users to whom secret information is opened, and the configuration of the screen is not particularly limited. For example, the screen may display an opening range divided by the groups of managerial positions in a selectable way as shown in FIG. 9A, or may individually display the users to whom the accesses of the secret information are allowed in a selectable way as shown in FIG. 9B. Alternatively, these display ways may be combined. Then, a user operates the operation section 18, for example, checks a desired check box, and thereby sets an opening range. At that time, the user may set the same opening range to all the specified positions, or may set different opening ranges to respective specified positions.

At Step S107, the control section 11 next obtains the set opening range information on the basis of the information from the operation section 18. Incidentally, if the opening range is always fixed, the specification of the opening range can be omitted.

At Step S108, the save control section 11a stores the original document data or the partial data obtained by the scanning by the scanner section 12 into the storage section 16 or the like. Incidentally, it is also possible to store the opening range information into the storage section 16 or the like in addition to the original document data or the partial data, and to set the right of access on the basis of the opening range information, and further to store the set right of access in the state of being related to the ID and the password of each opening range. Moreover, although the configuration of storing the original document data or the partial data in the storage section 16 of the image forming apparatus 10 is adopted here, for example, these pieces of data may be also stored in the server 20 in the case of the control system shown in FIG. 2.

At Step S109, the code generating section 11b codes the information (address information) at the saving position where the original document data or the partial data is stored and the opening range information to generate a one-dimensional bar code or a two-dimensional code.

As the one-dimensional bar codes, there are the codes of JAN, CODE 39, ITF, NW-7, CODE 128, CODE 93, and the like. The two-dimensional codes are classified to stack type two-dimensional codes and matrix type two-dimensional codes. As the stack type two-dimensional codes, there are the codes of PDF 417, CODE 49, CODE 16K, and the like. As the matrix type two-dimensional codes, there are the codes of QR codes, DATA MATRIX, VERI CODE, MAXI CODE, CP CODE, CODE 1, box figure codes, ULTRA CODE, AZTECH CODE, and the like. As long as a code is the one obtained by coding information and recoding the coded information, the code suffices the codes of the present embodiment, and the standards of the codes of the present embodiment are not especially limited. Moreover, the codes of the present embodiment are supposed to include the one obtained by optically recording information, such as a hologram.

At Step S110, the output control section 11c next produces a processed document 43 in which the specified positions in the original document 40 are painted out with a predetermined color such as a black color on the basis of the specified positional information and a code 45 generated at the preceding step is disposed at a predetermined position, as shown in FIG. 10. At Step S111, the output control section 11a allows the printer section 14 to print the processed document 43.

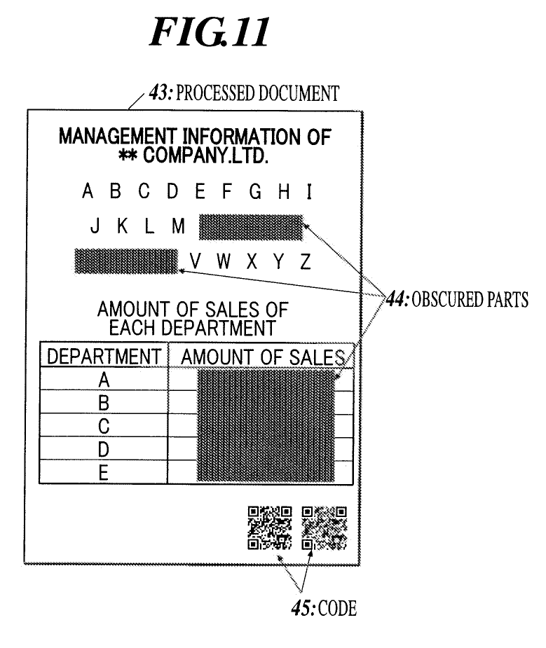

Incidentally, although the code 45 is disposed at the lower right in the processed document 43 in FIG. 10, the position at which the code 45 is disposed is arbitrary. Moreover, one code 45 is printed in FIG. 10, and the code 45 can be easily read with a cellular phone or the like in the case where there is one code 45. Accordingly, also the configuration of printing a plurality of codes 45 (two in this case) as shown in FIG. 11 by individually coding the information of the saving positions (address information) and the opening range information at Step S109 can be adopted. The reading of the code 45 with a cellular phone thereby becomes difficult to enable the heightening of the security of the code 45.

Moreover, the processed document 43 is not limited to the configurations shown in FIGS. 10 and 11, and, for example, it is also possible to paint out obscured parts 44 in the same color as that of the paper to be printed, or to delete the information corresponding to the obscured parts 44 so that nothing is printed at the obscured parts 44.

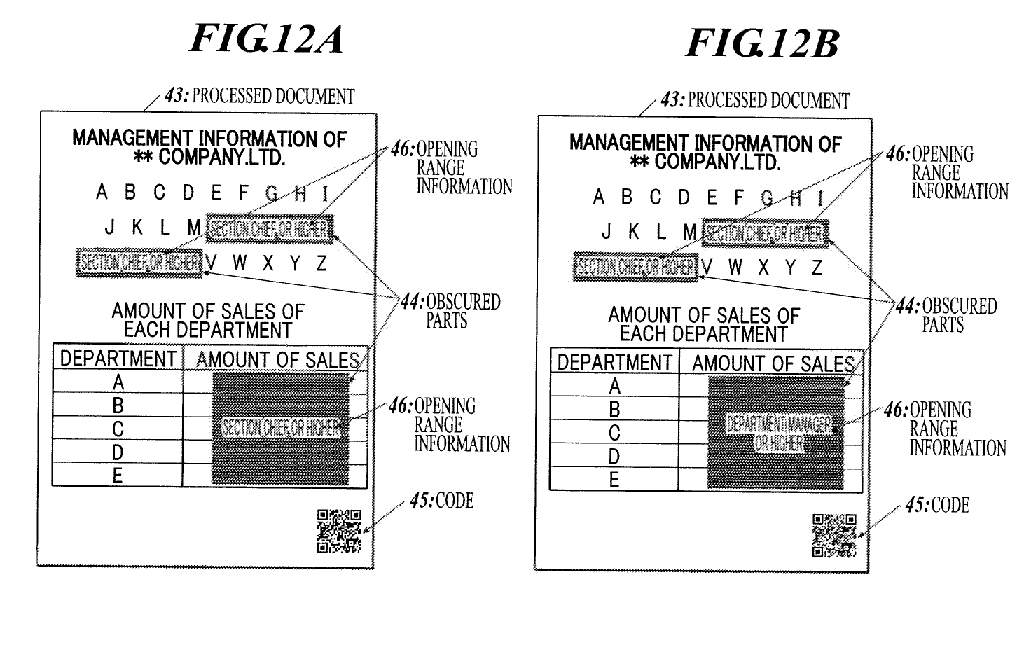

Moreover, if nothing is done besides the painting of the obscured parts 44 or the exclusion of printing in the obscured parts 44, then a user who looks at the processed document 43 cannot know whether the user has the authority of performing the access of the secret information or not. For example, as shown in FIG. 12A, it is also possible to print opening range information 46 in the obscured parts 44 (for example, in a color different from the painted color or as outlined characters) in a viewable state accordingly. In this case, as shown in FIG. 12B, it is also possible to print the pieces of the opening range information 46 differently from one another in the respective obscured parts 44.

Moreover, although the configuration of printing the processing document 43 is adopted in the flow mentioned above, the configuration of displaying the processed document 43 on a screen to allow a user to perform an access on the screen can be also adopted. In that case, only the thing required for the output control section 11c is to allow the display section 17 to display the processed document 43.

The procedure of the user who obtained the processed document to perform an access of secret information will be described next with reference to the flowchart of FIG. 6.

At Step S201, a user first sets the processed document 43 into the image forming apparatus 10, and the user operates the operation section 18 to instruct a scan. Then, the scanner section 12 scans the processed document 43 with the light source, and receives the light reflected by the processed document 43 with the CCD to convert the received light into an electric signal. The scanner section 12 then performs the A/D conversion of the electric signal to produce a scan image in which the information of the processed document 43 is recorded.

At Step S202, the image processing section 13 detects the code 45 from the scan image, and the authentication section 11d reads the address information of a data saving destination and the opening range information, both pieces of information recorded in the code 45. The detection method of the code 45 is not particularly limited, and the code 45 can be detected by the use of the publicly known wavelet transform or the Hough conversion. For example, a long straight line of a closing line expressing a border, a partition line, or the like is generally printed in the processed document 43 in consideration of a design performance, viewability, and the like, and the code 45 is printed to be in parallel and/or in perpendicular to the long straight line. Accordingly, by utilizing the long straight line as a reference line, it becomes possible to detect the code 45 efficiently. Incidentally, as for the detection of the code 45, for example, it is described in a prior application of the present applicant (Japanese Patent Application No. 2007-128226) in detail.

When the user next operates the operation section 18 to input authentication information such as an ID and a password, the authentication section 11d compares the ID and the password that are stored in the storage section 16 in advance with the ID and the password that have been input to authenticate the user at Step S203. Incidentally, the authentication method of the user is arbitrary, the method of authenticating the user by putting an IC card recording the ID of the user in the radio frequency identification (RFID) tag of the IC card above an RFID reader provided in the image forming apparatus 10 in advance, the method of authenticating the user by reading a finger print of the user, and the like can be also used.

At Step S204, the authentication section 11d refers to a table stored in the storage section 16 beforehand to authenticate whether the user agrees with the opening range read from the code 45 or not. If the user does not agree with the opening range (for example, in the case where the opening range requires being a section chief or higher and the user is a chief clerk), then the authentication section 11d judges that the secret information cannot be opened to the user. Then, the control section 11 allows the display section 17 to display the prohibition of opening at Step S208, and terminates the processing.

On the other hand, if the user agrees with the opening range of the secret information (for example, in the case where the opening range requires being a section chief or higher and the user is a section chief or a department manager), then the control section 11 accesses the saving position specified by the address information read from the code 45 at Step S205, and reads original document data or partial data from the saving position at Step S206. Then, at Step S207, the control section 11 allows the display section 17 to display the original document data or the partial data to inform the user having access authority of the obscured secret information.

Incidentally, the display form of the partial data is not especially limited, but, for example, as shown in FIG. 13A, the pieces of information recorded at specified positions may be displayed at the specified positions, or as shown in FIG. 13B, the pieces of information recorded at the specified positions may be enumerated to be displayed in a way of enabling the user to know the correspondence relations with the specified positions (in the order from the uppermost specified position here).

Moreover, a user who does not agree with the opening range can read secret information by, for example, reading the code 45 with a cellular phone to access the server 20 when the original document data or the partial data is stored in the server 20, and that situation is not preferable in view of security. It is accordingly possible to adopt the following system: a password to each opening range is previously registered in the storage section 16 of the image forming apparatus 10; the authentication section 11d generates the passwords agreeing with the opening ranges and transmits the generated passwords to the server 20; and the server 20 allows the reading of the original document data or the partial data when one of the specific passwords is transmitted.

In such a way, the image forming apparatus 10 is provided with the save control section 11a, the code generating section 11b, the output control section 11c, and the authentication section 11d, as hardware or software. Original document data or partial data is stored in a predetermined saving position. The code 45 recording the address information of the predetermined saving position and opening range information is generated. The specified positions of the original document 40 are painted out. The opening range information is further added to the specified positions. The processed document 43, in which the code 45 is added at a predetermined position, is then printed or displayed. Thereby, the leak of secret information can be surely prevented. Moreover, obscured secret information can be surely informed to the user who agrees with the opening range by enabling the user to read the code 45 of the processed document 43 to access the saving position.

The reason is as follows: the original document data including secret information or the partial data at the specified positions of the original document is saved at the predetermined saving position; the specified positions are obscured; the processed document in which the code recording the address information of the predetermined saving position and opening range information is added is printed or displayed; and consequently, a user who does not agree with the opening range cannot perform an access of the secret information at the specified positions, and a user who agrees with the opening range can read the code to access the saving position, so that the user can perform an access of the secret information.

Moreover, the reason is as follows: the opening range information is added to the obscured parts and the processed document is printed or displayed; and thereby a user who obtains a processed document can easily judge whether the user agrees with the opening range or not.

### Second Embodiment

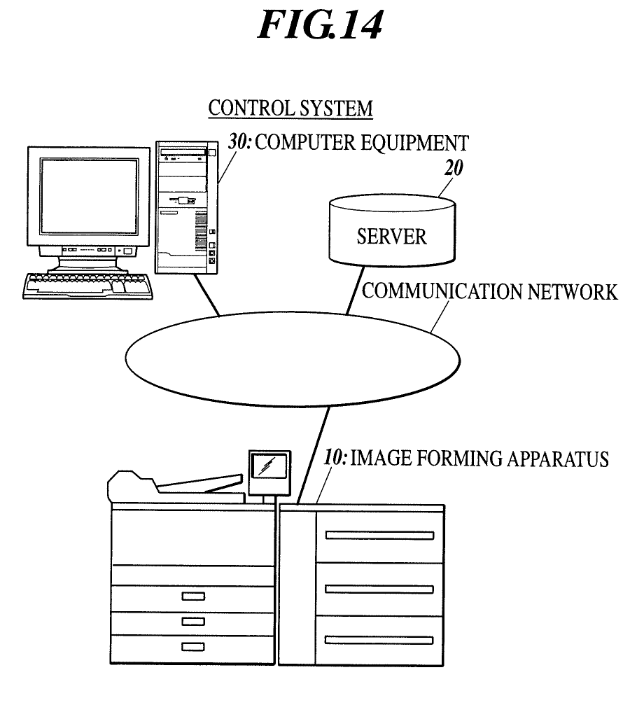

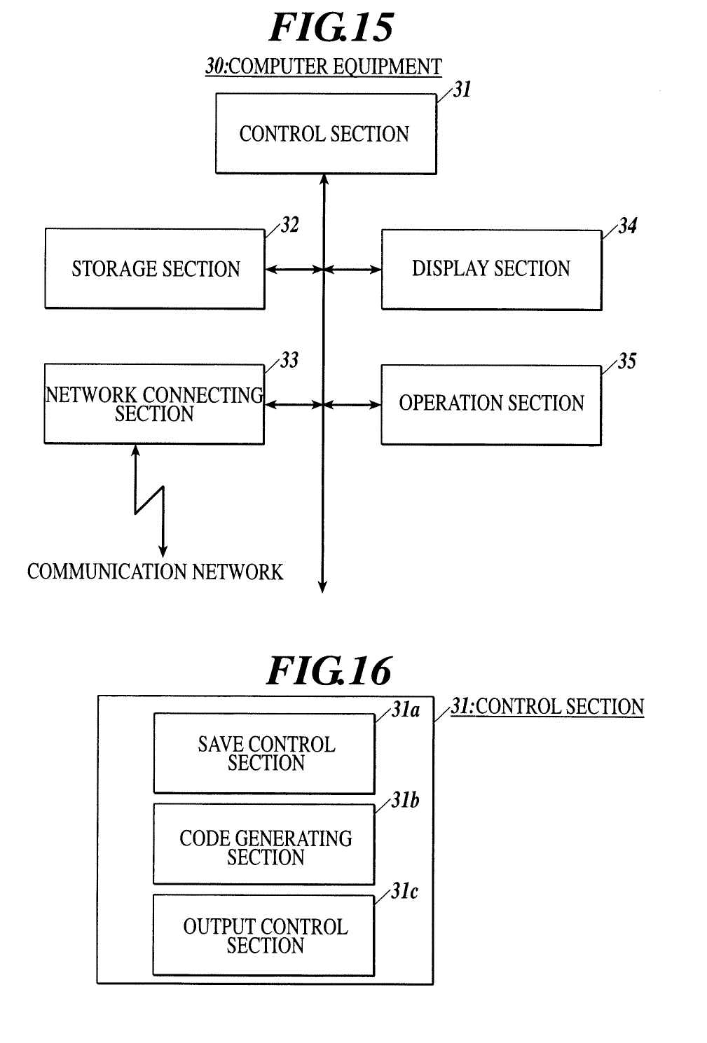

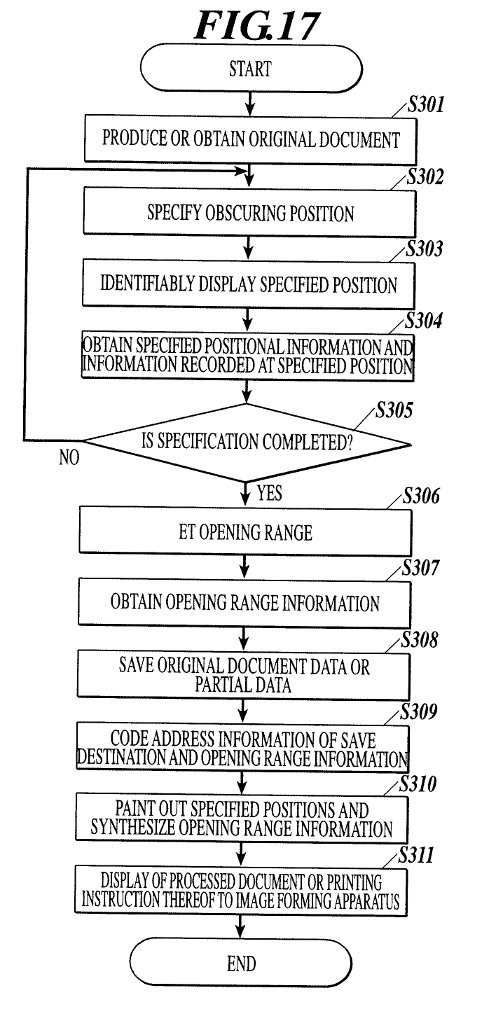

A control program, an image forming apparatus, a control system, and a control method according to a second embodiment of the present invention will be described next with reference to FIGS. 14-17. FIG. 14 is a view schematically showing the configuration of the control system of the present embodiment; FIG. 15 is a block diagram showing the configuration of computer equipment of the present embodiment; and FIG. 16 is a block diagram showing the configuration of the control section of the computer equipment. Moreover, FIG. 17 is a flowchart showing a procedure of producing a document, saving data, and outputting the saved data by means of the control system of the present embodiment.

In the first embodiment described above, the case where the control system is composed of only the image forming apparatus 10, or the image forming apparatus 10 and the server 20 is shown. But, the production of the original document 40, the specification of the positions to be obscured, the setting of the opening range, and the outputting of the processed document 43 can be also executed by computer equipment, such as a personal computer. The present embodiment is accordingly configured so that the control system thereof may include the image forming apparatus 10, computer equipment 30, and the server 20 if needed, each connected through a communication network, as shown in FIG. 14.

In the case of the present embodiment, the computer equipment 30 is composed of a control section 31, a storage section 32, a network connecting section 33, a display section 34, an operation section 35, and the like, and each section is connected with one another through a bus, as shown in FIG. 15.

The control section 31 is composed of a CPU, a ROM, a RAM, and the like. The CPU reads various programs stored in the ROM by an operation of the operation section 35, and expands the read programs in the RAM. The CPU controls the operation of each section of the computer equipment 30 in accordance with the expanded programs.

The storage section 32 is composed of a flash memory, a hard disk, or the like, and stores various data, set conditions, and the like. In the present embodiment, the storage section 32 especially stores original document data or partial data, a table defining an opening range, IDs and passwords for authenticating a user, a password to each opening range, and the like.

The network connecting section 33 is composed of a NIC, a modem, a LAN adapter, a router, a TA, and the like, and performs the control of communications with the image forming apparatus 10 and the server 20, which are connected through the communication network.

The display section 34 is composed of a liquid crystal display apparatus, an organic EL display apparatus, or the like. The display section 34 displays a screen for specifying an obscuring position in an original document, a screen for setting an opening range, and the like, on the screen of the display section 34 in accordance with a display signal from the control section 31. Moreover, the operation section 35 is composed of a keyboard, a mouse, and the like. The operation section 35 enables the operations such as specifying an obscuring position in an original document and setting an opening range on the screens displayed by the display section 34. Incidentally, the display section 34 and the operation section 35 may be formed as apparatus separated from each other, or may be formed as a touch panel in which the display section 34 and the operation section 35 are formed in a body.

Moreover, in addition to the control of the operation of each section of the computer equipment 30, the control section 31, as shown in FIG. 16, also functions as a save control section 31a saving original document data or partial data at a predetermined saving position, a code generating section 31b generating a code such as a one-dimensional bar code or a two-dimensional code that records the address information of the saving position and the opening range information, and an output control section 31c, which displays a processed document produced by painting out the specified positions in an original document and by adding a code to the original document, or which output control section 31C allows the image forming apparatus 10 to print the processed document.

Incidentally, the save control section 31a, the code generating section 31b, and the output control section 31c may be configured as hardware or may be configured as a control program making the computer equipment 30 function as the save control section 31a, the code generating section 31b, and the output control section 31c to be operated on the control section 31.

Moreover, in the case of the configuration of the present embodiment, the control section 11 of the image forming apparatus 10 does not necessarily function as the save control section 11a, the code generating section 11b, and the output control section 11c, but the only thing required for the control section 11 is to function as the authentication section 11d.

In the following, a procedure of from producing a processed document to outputting the produced processed document by means of the control system configured as above will be described with reference to the flowchart of FIG. 17.

At Step S301, an original document 40 is first produced by means of a document producing application stored in the storage section 32 beforehand, or original document data stored in the storage section 32 beforehand is read. Alternatively, original document data is obtained from another piece of equipment connected to the control system through the communication network. Then the control section 31 allows the display section 34 to display the obscuring position specifying screen 50 as shown in FIG. 8A.

At Step S302, a user next specifies one or a plurality of obscuring positions by operating the operation section 35. Then, at Step S303, the control section 31 allows the display section 34 to identifiably display the obscuring positions specified by the operation section 34.

At Step S304, the control section 31 next obtains the specified positional information on the basis of the information from the operation section 35. Moreover, in the case of saving partial data, the control section 31 obtains the pieces of information recorded at the specified positions. Then, when the specification of the obscuring positions has been completed at Step S305, the control section 31 allows the display section 34 to display an opening range setting screen at Step S306. The user operates the operation section 35 to set one or a plurality of opening ranges by checking one or a plurality of desired check boxes, or the like.

At Step S307, the control section 31 next obtains the set opening range information on the basis of the information from the operation section 35. At Step S308, the save control section 31a stores the original document data or the partial data into the storage section 32 or the server 20. Incidentally, it is also possible similarly to the first embodiment to store the opening range information into the storage section 32 or the like in addition to the original document data or the partial data, and to set the right of access on the basis of the opening range information, and further to store the set right of access in the state of being related to the ID and the password of each opening range.

At Step S309, the code generating section 31b codes the address information, at the saving position where the original document data or the partial data is stored, and the opening range information to generate one or a plurality of codes, such as a one-dimensional bar code and a two-dimensional code.

At Step S310, the output control section 31c next produces a processed document 43 in which the specified positions in the original document 40 are painted out with a predetermined color such as a black color on the basis of the specified positional information and a code 45 generated at the preceding step is disposed at a predetermined position, as shown in FIG. 10. At Step S311, the output control section 31c allows the display section 34 to display the processed document 43, or converts the processed document 43 into the one described by a page description language (PDL) and transmits the converted processed document 43 to the image forming apparatus 10 to allow the image forming apparatus 10 to print the processed document 43.

Incidentally, the position at which the code 45 is disposed is arbitrary similarly to the first embodiment. Also the control section 31 may display or print two codes 45 as shown in FIG. 11 by individually coding the information of the saving positions (address information) and the opening range information. Moreover, it is also possible to paint out obscured parts 44 in the same color as that of the paper to be printed, or to delete the data corresponding to the obscured parts 44 so that nothing is printed at the obscuring positions on the paper. Moreover, as shown in FIGS. 12A and 12B, it is also possible to display or print opening range information 46 in the obscured parts 44 in a viewable state.

After that, the user obtained the processed document 43 scans the processed document 43 with the image forming apparatus 10, and the image forming apparatus 10 reads the code 45 to access the saving position, in conformity with the flowchart of FIG. 6 of the first embodiment. Then, the image forming apparatus 10 allows a user agreeing with the opening range to read the original document data or the partial data, and enables the user to perform an access of the pieces of information recorded at the specified positions.

In such a way, the compute equipment 30 is provided with the save control section 31a, the code generating section 31b, and the output control section 31c, as hardware or software. Original document data or partial data is stored in a predetermined saving position. The code 45 recording the address information of the predetermined saving position and opening range information is generated. The specified positions of the original document 40 are painted out. The pieces of opening range information are added to the specified positions. The processed document 43, in which the code 45 is added at a predetermined position, is then displayed or printed by the image forming apparatus 10. Thereby, the similar advantages to those of the first embodiment can be obtained.

Incidentally, although the configuration such that the computer equipment 30 performs the specification of the obscuring positions of the original document 40, the setting of the opening ranges, the saving of data, the display or the instruction of the printing of the processed document 43 is adopted in the description mentioned above, also the configuration such that the computer equipment 30 performs the specification of the obscuring positions in the original document 40, the setting of the opening ranges, and the saving of the data, and the image forming apparatus 10 performs the printing or the display of the processed document 43 can be adopted.

Moreover, in each embodiment described above, the configuration of producing the processed document 43 in which the specified positions of the original document 40 are painted out and the code 45 is added is adopted, but the present invention is not limited to the embodiments described above, but only the thing required to the present invention is to obscure the specified positions in the original document 40 so as to be impossible to be looked at, and to enables the user having access authority to perform an access of the information recorded at the specified positions. For example, the modifications such as printing the address information of the saving position or pasting an RFID tag recording the address information in place of the code 45 or together with the code 45 can also be adopted.

The present invention can be utilized in a computer readable medium embodying a control program having the function of controlling the production, the saving, the outputting, the access of a document including secret information; an image forming apparatus and computer equipment that are provided with the function; and a control system including the image forming apparatus and the computer equipment; and a control method.

The present U.S. patent application claims a priority under the Paris Convention of Japanese patent application No. 2007-155687 filed on Jun. 12, 2007, which shall be a basis of correction of an incorrect translation.

What is claimed is:

1. A computer readable medium embodying a control program enabling a computer to function as:
a save control section to save document data of a first document including secret information at a predetermined saving position;
a code generating section to generate a code in which address information of the saving position and opening range information defining an opening range of users to whom the secret information is opened are recorded; and
an output control section to enable printing or displaying a second document in which a specified position of the first document is obscured and the code is added.

2. The computer readable medium embodying the control program of claim 1, the control program further enabling the computer to function as:
an authentication section to authenticate whether a user utilizing the second document agrees with the opening range defined by the opening range information read from the code or not based on input authentication information, the authentication section allowing the computer to read the document data from the saving position specified by the address information read from the code when the user agrees with the opening range.

3. The computer readable medium embodying the control program of claim 1, wherein the output control section enables printing or displaying the opening range information at the obscured specified position in the first document in a viewable state.

4. A computer readable medium embodying a control program enabling a computer to function as:
a save control section to save partial data at a specified position in a first document including secret information at a predetermined saving position;
a code generating section to generate a code in which address information of the saving position and opening range information defining an opening range of users to whom the secret information is opened are recorded; and
an output control section to enable printing or displaying of a second document in which the specified position in the first document is obscured and the code is added.

5. The computer readable medium embodying the control program of claim 4, the control program further enabling the computer to function as:
an authentication section to authenticate whether a user utilizing the second document agrees with the opening range defined by the opening range information read from the code or not based on input authentication information, the authentication section allowing the computer to read the partial data from the saving position specified by the address information read from the code when the user agrees with the opening range.

6. The computer readable medium embodying the control program of claim 4, wherein the output control section enables printing or displaying the opening range information at the obscured specified position in the first document in a viewable state.

7. An image forming apparatus, comprising:
a display section to display a first document including secret information;
an operation section to enable specifying a position to be obscured in the first document and setting opening range information defining an opening range of users to whom the secret information is opened;
a save control section to save document data of the first document at a predetermined saving position;
a code generating section to generate a code in which address information of the saving position and the opening range information are recorded; and
an output control section to enable printing or displaying a second document in which the specified position of the first document is obscured and the code is added.

8. The image forming apparatus of claim 7, further comprising:
a scan section to scan the second document;
an image processing section to detect the code from a scan image; and
an authentication section to authenticate whether a user utilizing the second document agrees with the opening range defined by the opening range information read from the code or not based on input authentication information, the authentication section allowing the computer to read the document data from the saving position specified by the address information read from the code when the user agrees with the opening range.

9. The image forming apparatus of claim 7, wherein the output control section enables printing or displaying the opening range information at the obscured specified position in the first document in a viewable state.

10. An image forming apparatus, comprising:
a display section to display a first document including secret information;
an operation section to enable specifying a position to be obscured in the first document and setting opening range information defining an opening range of users to whom the secret information is opened;
a save control section to save partial data at an specified position in the first document at a predetermined saving position;
a code generating section to generate a code in which address information of the saving position and the opening range information are recorded; and
an output control section to enable printing or displaying a second document in which the specified position in the first document is obscured and the code is added.

11. The image forming apparatus of claim 10, further comprising:
a scan section to scan the second document;
an image processing section to detect the code from a scan image; and
an authentication section to authenticate whether a user utilizing the second document agrees with the opening range defined by the opening range information read from the code or not based on input authentication information, the authentication section allowing the computer to read the partial data from the saving position specified by the address information read from the code when the user agrees with the opening range.

12. The image forming apparatus of claim 10, wherein the output control section enables printing or displaying the opening range information at the obscured specified position in the first document in a viewable state.

13. A control system in which an image forming apparatus and computer equipment are connected to each other through a communication network, wherein
the computer equipment including:
a display section to display a first document including secret information;
an operation section to enable specifying a position to be obscured in the first document and to set opening range information defining an opening range of users to whom the secret information is opened;
a save control section to save document data of the first document at a predetermined saving position;
a code generating section to generate a code in which address information of the saving position and the opening range information are recorded; and
an output control section to allow the display section to display a second document in which the specified position in the first document is obscured and the code is added, or to allow the image forming apparatus to print the second document.

14. The control system of claim 13, wherein the image forming apparatus includes:
a scan section to scan the second document;
an image processing section to detect the code from a scan image; and
an authentication section to authenticate whether a user utilizing the second document agrees with the opening range defined by the opening range information read from the code or not based on input authentication information, and to allow the computer to read the document data from the saving position specified by the address information read from the code when the user agrees with the opening range.

15. The control system of claim 13, wherein the output control section enables printing or displaying the opening range information at the obscured specified position in the first document in a viewable state.

16. The control system of claim 13, wherein:
a server is connected to the communication network;
the save control section of the computer equipment saves the document data in the server so as to be related to the opening range information;
the authentication section of the image forming apparatus generates a password corresponding to the opening range read from the code, and transmits the password to the server; and
the server enables reading the document data when the password is transmitted.

17. A control system comprising an image forming apparatus and computer equipment, both connected to each other through a communication network, wherein
the computer equipment includes:
a display section to display a first document including secret information;
an operation section to enable specifying a position to be obscured in the first document and to set opening range information defining an opening range of users to whom the secret information is opened;
a save control section to save partial data at a specified position in the first document at a predetermined saving position;
a code generating section to generate a code in which address information of the saving position and the opening range information are recorded; and
an output control section to allow the display section to display a second document in which the specified position of the first document is obscured and the code is added, or to allow the image forming apparatus to print the second document.

18. The control system of claim 17, wherein the image forming apparatus includes:
a scan section to scan the second document;
an image processing section to detect the code from a scan image; and
an authentication section to authenticate whether a user utilizing the second document agrees with the opening range defined by the opening range information read from the code or not based on input authentication information, and to allow the computer to read the partial data from the saving position specified by the address information read from the code when the user agrees with the opening range.

19. The control system of claim 17, wherein the output control section enables printing or displaying the opening range information at the obscured specified position in the first document in a viewable state.

20. The control system of claim 17, wherein:
a server is connected to the communication network;
the save control section of the computer equipment saves the partial data in the server so as to be related to the opening range information;
the authentication section of the image forming apparatus generates a password corresponding to the opening range read from the code, and transmits the password to the server; and
the server enables reading the partial data when the password is transmitted.

21. A control method comprising the steps of:
displaying a first document including secret information;
specifying a position to be obscured in the first document to set an opening range information defining an opening range of users to whom the secret information is opened;
saving document data in the first document at a predetermined saving position;
generating a code in which address information of the saving position and the opening range information are recorded; and
displaying or printing a second document in which the specified position of the first document is obscured and the code is added.

22. The control method of claim 21, further comprising the steps of:
scanning the second document;
detecting the code from a scan image; and
authenticating whether a user utilizing the second document agrees with the opening range defined by the opening range information read from the code or not based on input authentication information to allow the computer to read the document data from the saving position specified by the address information read from the code when the user agrees with the opening range.

23. The control method of claim 21, wherein the displaying or printing step displays or prints the opening range information at the obscured specified position of the first document.

24. The control method of claim 21, wherein
the saving step saves the document data so as to be related to the opening range information;
the control method further comprises the steps of:
generating a password corresponding to the opening range information; and
transmitting the generated password to the saving position to enable reading the document data at the saving position when the password is transmitted thereto.

25. A control method comprising the steps of:
displaying a first document including secret information;
specifying a position to be obscured in the first document to set opening range information defining an opening range of users to whom the secret information is opened;
saving partial data at a specified position in the first document at a predetermined saving position;
generating a code in which address information of the saving position and the opening range information are recorded; and
displaying or printing a second document in which the specified position of the first document is obscured and the code is added.

26. The control method of claim 25, further comprising the steps of:
scanning the second document;
detecting the code from a scan image; and
authenticating whether a user utilizing the second document agrees with the opening range defined by the opening range information read from the code or not based on input authentication information to allow the computer to read the partial data from the saving position specified by the address information read from the code when the user agrees with the opening range.

27. The control method of claim 25, wherein the displaying or printing step displays or prints the opening range information at the obscured specified position of the first document.

28. The control method of claim 25, wherein
the saving step saves the partial data so as to be related to the opening range information;
the control method further comprises the steps of:
generating a password corresponding to the opening range information; and
transmitting the generated password to the saving position to enable reading the partial data at the saving position when the password is transmitted thereto.
